(19) United States
(12) Patent Application Publication
(10) Pub. No.: US 2024/0007385 A1
(43) Pub. Date: Jan. 4, 2024

(54) AUTOMATED METHODS AND SYSTEMS FOR SIMULATING A RADIO ACCESS NETWORK

(71) Applicant: VMware, Inc., Palo Alto, CA (US)

(72) Inventors: Yan Qi, Beijing (CN); Jian Lan, Beijing (CN); Liang Cui, Beijing (CN); Xiaoli Tie, Beijing (CN); Weiqing Wu, Beijing (CN); Aravind Srinivasan, Palo Alto, CA (US); Doug MacEashern, San Francisco, CA (US)

(73) Assignee: VMware, Inc., Palo Alto, CA (US)

(21) Appl. No.: 17/887,761

(22) Filed: Aug. 15, 2022

(30) Foreign Application Priority Data
Jul. 4, 2022 (WO) PCT/CN2022/103606

(51) Int. Cl. H04L 43/50; H04L 41/14; G06F 9/54

(52) U.S. Cl. CPC H04L 43/50; H04L 41/145; G06F 9/547

(57) ABSTRACT

This disclosure is directed to a simulation system that verifies functionality and performance of an automated telecommunication cloud platform (“TCP”) which is used to configure hosts of cell sites and a mobile core of a 5G cellular network. The mock hosts are created with a required virtualization platform inventory of objects for implementing a 5G cellular network and registers the mock hosts with a mock centralized server management platform (“mock VC”). The mock hosts are used to simulate hosts of cell sites and a mobile core of a 5G cellular network using features of the TCP. Scale tests are used to verify functionality and performance of the TCP are performed on the mock hosts without any changes to the TCP.

### TECHNICAL FIELD

The present disclosure is directed to simulating host systems of a radio access network.

### BACKGROUND

Over the past few decades, mobile networks have undergone significant changes to keep pace with the increasing demand for wireless communication. The first- and second-generation network technology (i.e., 1G and 2G) supported voice and then text messages. The third-generation network technology (“3G”) provided broadband access, supporting data rates that measured in hundreds of KB per second. The fourth-generation network technology (“4G”) replaced 3G by providing even faster broadband data rates with latency ranges from 60 to 98 milliseconds and a peak transmission speed of about 1 GB/s, which supports mobile web access. IP telephony, gaming services, high-definition mobile TV, and video conferencing.

In recent years, communication service providers (“CSPs”) have started building a faster fifth-generation network technology (5G′). 5G is expected to deliver a latency of under 5 milliseconds and provide transmission speeds up to about 20 GB/s. With these advancements in speed, 5G is expected to support higher speed and more reliable mobile communications and video streaming services, immersive user interfaces, mission-critical applications (e.g., public safety, autonomous vehicles), smart home appliances, industrial robots, and the Internet-of-Things (“IoT”). Because these use cases include everything from home appliances to industrial robots to autonomous vehicles, 5G will not just support humans accessing the Internet from their mobile phones but will also support autonomous devices that work together.

However, building a 5G cellular network is a challenging and expensive process. 5G relies on high frequency low strength radio waves that diminish over much shorter distances than low frequency high strength radio waves used with 4G. For example, 4G radio waves have a range of about 10 miles. By contrast, 5G radio waves have a range of about 1,000 feet or roughly 2% of the range of 4G. As a result, to practically implement 5G, CSPs must deploy far more closely located 5G cell sites per unit area than 4G cell sites. CSPs expect to use various technologies that significantly reduce the size of 5G cell sites in densely populated areas and will continue to use cell towers to transmit radio waves in the lower frequency part of the spectrum used with 5G. However, given the expected high densities of 5G cell sites, various frequency spectrums, and the variety of different components that can be used to implement a 5G cellular network. CSPs seek automated processes and systems for modeling deployment of the various technologies that can be used to implement 5G cell sites over a variety of different regions.

### SUMMARY

This disclosure is directed to a simulation system that verifies functionality and performance of an automated telecommunication cloud platform (“TCP”) which is used to configure hosts of cell sites and a mobile core of a 5G cellular network. The simulation system creates mock hosts of cell sites and a mobile core of a 5G radio access network (“RAN”) with a required inventory of objects used implement the 5G RAN. The simulation system registers the mock hosts with a mock centralized server management platform (“VC”). The simulation system comprehensively simulates hosts of the cell sites and the mobile core using features of the TCP. The simulation system verifies functionality and performance of the TCP based on the mock VC and the mock hosts.

### DESCRIPTION OF THE DRAWINGS

FIG. 1 shows an example of a cellular network.

FIG. 2A shows a cell site and a mobile core.

FIG. 2B shows an example virtual machine (“VM”) execution environment run on a computer system.

FIG. 2C shows an example container execution environment run on a computer system.

FIGS. 3A-3C show how a cell site interacts with the mobile core to establish communications with user equipment (“UE”).

FIG. 4 shows an example of handing over a cell site connection with a UE to a neighboring cell site.

FIG. 5 shows an example of a software designed data center (“SDDC”) deployed in a regional data center (“RDC”).

FIG. 6 shows components of the SDDC that runs on the RDC.

FIGS. 7A-7D show an example of configuring hosts of a cellular network.

FIG. 8 shows components of the SDDC that runs on the RDC and includes a simulation system.

FIG. 9 shows an example workflow for configuring mock hosts of cell sites and a local data center (“LDC”) of a cellular network.

FIG. 10 shows an example input to start a simulation system.

FIG. 11 shows example details of mock hosts future deployment in cell sites and an LDC in a cellular network.

FIG. 12 shows an example automated telecommunication cloud platform (“TCP”) user interface for configuring the mock VC with the simulation system.

FIG. 13 shows an example TCP user interface for adding a mock host of a cell site.

FIGS. 14A-14B shows an exploded view of a simulation system for creating mock hosts of RAN cell sites and a mobile core of an LDC.

FIG. 15 shows an example of a VC simulator.

FIG. 16 shows an example of a mock host of a cell site that is created and registered with the mock VC in FIG. 15.

### DETAILED DESCRIPTION

A cellular network provides wireless connectivity to moving devices and comprises two primary subsystems: a radio access network (“RAN”) and a mobile core connected to the Internet. This disclosure presents a simulation system that verifies functionality and performance of an automated telecommunication cloud platform (“TCP”) which is used to configure hosts of cell sites and a mobile core of a 5G cellular network.

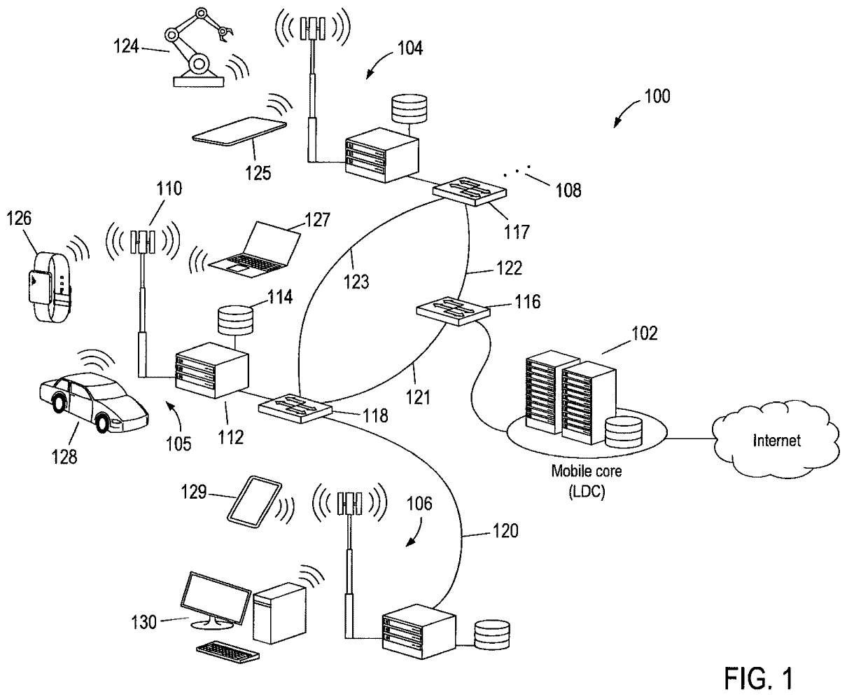

FIG. 1 shows an example of a cellular network 100. The cellular network 100 includes a mobile core 102 and a RAN composed of cell sites, such as example cell sites 104-106. In practice, a RAN can span dozens or even hundreds of cell sites as represented by ellipsis 108. Each cell site includes an antenna, one or more computer systems, and a data storage appliance. For example, cell site 105 includes an antenna 110 located on a tower, computer systems 112, and a data storage appliance 114. The cells sites are located at the edge of the cellular network 100. The mobile core 102 is the center of the cellular network 100. The cellular network 100 includes a backhaul network that comprises the intermediate links, such as cables, optical fibers, and switches, and connects the mobile core 102 to the cell sites. In the example of FIG. 1, the backhaul network includes switches 116-118 and intermediate links 120-123. In one implementation, the intermediate links can be optical fibers. In other implementations, the backhaul network may be implemented with wireless communications between cells sites and the mobile core 102. The cellular network 100 provides wireless 5G connectivity to user equipment (“UE”). UEs include mobile phones, computers, automobiles, drones, industrial and agricultural machines, robots, home appliances, and IoT devices. FIG. 1 shows examples of UEs, such a robot 124, a tablet 125, a watch 126, a laptop 127, an automobile 128, a mobile phone 129, and a computer 130. The mobile core 102 is implemented in a local data center (“LDC”) that provides a bundle of services. For example, the mobile core 102 provides (1) Internet connectivity for both data and voice services; (2) ensures the connectivity satisfies quality-of-service (“QoS”) requirements of CSPs; (3) tracks UE mobility to ensure uninterrupted service as users travel; and (4) tracks subscriber usage for billing and charging. The mobile core 102 provides a bridge between the RAN in a geographic area and a larger IP-based Internet.

The computer systems at each cell site run management services that maintain the radio spectrum used by the UEs, make sure the cell site is used efficiently and meets QoS requirements of the UEs that communicate with the cell site. The functions performed by the cell sites and the mobile core 102 are partitioned into a management plane, a control plane, and a user plane.

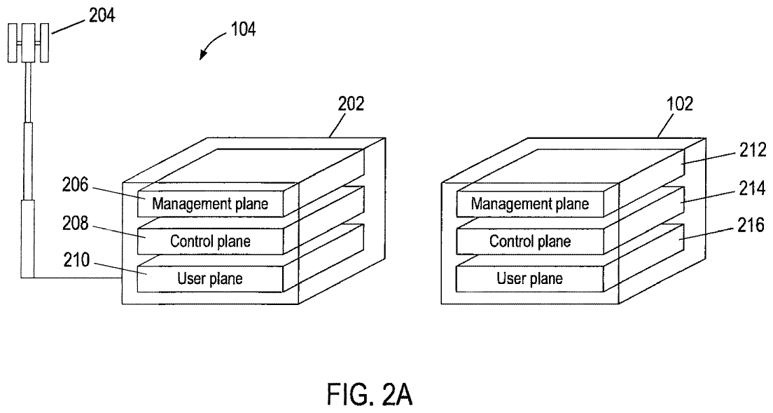

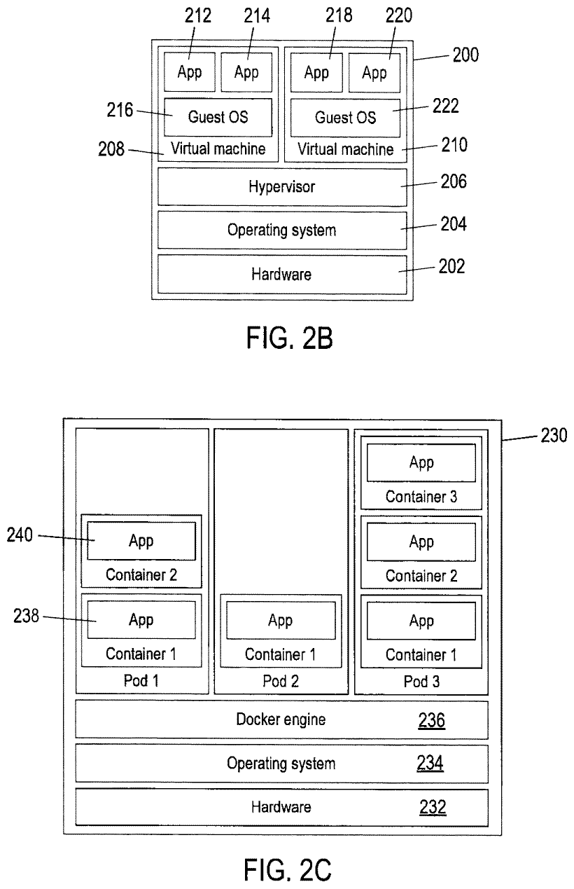

FIG. 2A shows the cell site 104 and the mobile core 102. The cell site includes computer systems 202 and an antenna 204. As shown in FIG. 2, the functions performed by the computer system 202 and the mobile core 102 include management planes, control planes, and user planes. The planes are abstracted to represent processes performed by the computer systems 202 and the mobile core 102. The management planes 206 and 212 of the cell site 104 and the mobile core 102, respectively, configure, monitor, and provide management, monitoring, and configuration services to all layers of the network. The management planes 206 and 212 carry the administrative traffic, which includes configuration and control commands for the RAN and mobile core functions. The user planes 210 and 216 of the cell site 104 and the mobile core 102, respectively, are protocol stacks that consists of sub-layers, such as packet data convergence protocol (“PDCP”), radio link control (“RLC”), and medium access control (“MAC”), carry user voice and multimedia traffic between the UEs and the Internet. The control planes 208 and 214 include a radio resource control (“RCC”) layer that is responsible for configuring the user planes 210 and 216 to control how data packets are sent between the UEs and the Internet. For example, the control plane 208 controls how data is forwarded from UEs to the mobile core 102 and controls handing over of the UEs to neighboring cell sites as discussed below. The control plane 214 controls how data is forwarded from the mobile core 102 to the cell site 104 and to the Internet.

The management plane, control plane, and user plane functionalities performed at the cells cites and the mobile core 102 are implemented in distributed applications with application components that are run in virtual machines (“VMs”) or in containers that run on computer systems located at the cell sites and the mobile core 102. A VM is a computing resource that uses software instead of a physical computer to run programs and applications. Each VMs runs at least one application or program on its own operating system (“guest OS”) and functions separately from other VMs running on the same computer system. A container, on the other hand, is an abstraction at the application layer that packages code and dependencies together. Multiple containers can run on the same computer system and share the operating system kernel, each running as an isolated process in the user space. One or more containers run in pods. The containers are isolated from one another and bundle their own software, libraries, and configuration files within the pods.

FIG. 2B shows an example VM execution environment run on a computer system 200. The computer system 200 includes a hardware layer 202 composed of processors, memory, storage, and 5G devices, such as at least one high speed network interface card. The computer system includes an operating system layer 204 that manages computer hardware, software resources, and provides services for computer programs executing on the computer system. VMs 208 and 210 execute on a hypervisor 206 as denoted by “ESX.” The hypervisor 206 creates and runs the VMs 208 and 210 and allocates and abstracts resources of the hardware layer 202, such as CPU, memory, storage, and network access, to the VMs 208 and 210. VM 208 runs two applications 212 and 214 on a guest OS 216. VM 210 runs two application 218 and 220 on a guest OS 222. The guest OSs 216 and 222 can be different and can be different from the operating system 204 of the computer system.

FIG. 2C shows an example container execution environment run on a computer system 230. The computer system 230 includes a hardware layer 232 composed of processors, memory, storage, and 5G devices, such as at least one high speed network interface card. The computer system 230 includes an operating system layer 234 that manages computer hardware, software resources, and provides services for computer programs executing on the computer system. Docker engine 236 is a server application for containerizing applications. In this example, applications are run separately in containers that are in turn run in pods identified as Pod 1, Pod 2, and Pod 3. Each pod runs one or more containers with shared storage and network resources, according to a specification for how to run the containers. For example. Pod 1 runs an application 238 in a container identified as container 1 and another application 240 in a container identified as container 2. An application running in a pod is a workload and the computer system, such as the computer system 230, with applications running in containers of pods is called a “worker node.”

The computer systems 200 and 230 are examples of host computer systems or simply “hosts.” A host is a computer system that communicates with other computer systems on a network, such as the cellular network shown in FIG. 1.

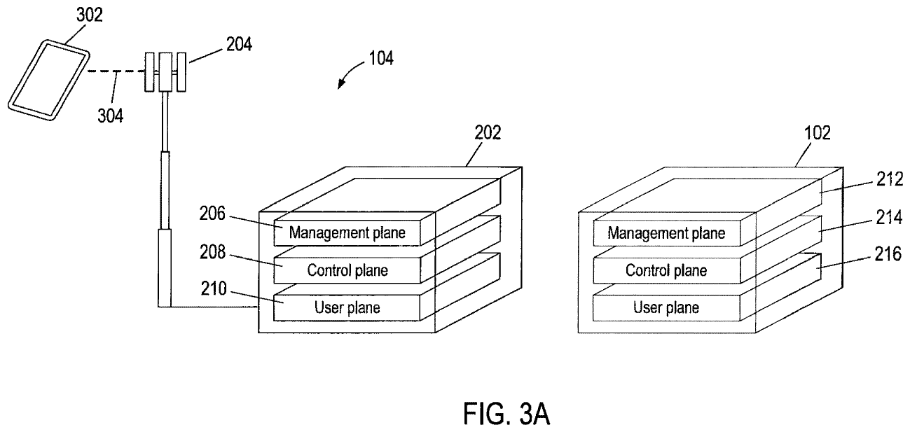

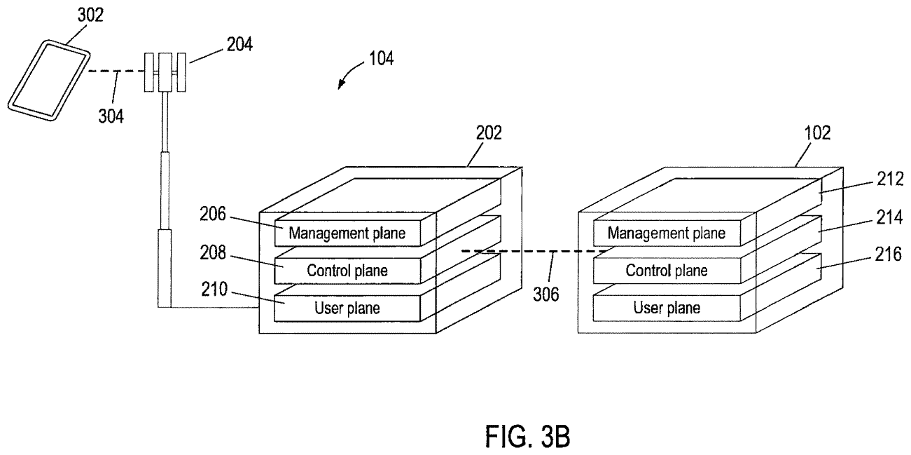

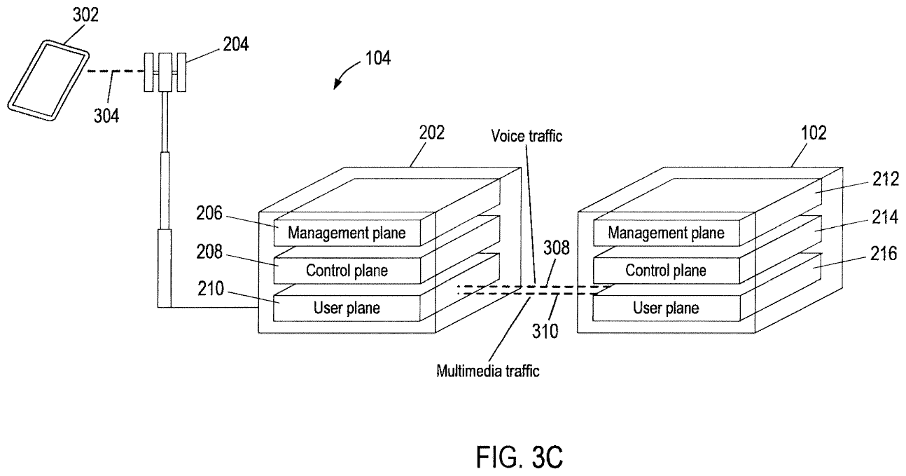

FIGS. 3A-3C show how the cell site 104 interacts with the mobile core 102 to establish communications with a UE 302 on a RAN. In FIG. 3A, the cell site 104 detects the UE 302 when the UE 302 is powered up or when the signal produced by the UE is close enough to be detected by the antenna 204. The control plane 208 establishes a wireless channel via the user plane 210 with the UE 302 as represented by dashed line 304. The channel 304 is released when the UE 302 is idle for a predetermined period of time, powered off, or handed over to a neighboring cell site as described below. The control plane 208 receives signaling traffic from the UE 302. The signaling traffic enables authentication, registration, and mobility tracking of the UE 302. For example, the signaling traffic may include information contained in a SIM card of the UE 302, such as the international mobile subscriber identity (“IMSI”). The IMSI contains the mobile country code (“MCC”) and the mobile network code (“MNC”) as prefixes, which are used for identifying the carrier network of the SIM card. In addition, the IMSI includes the mobile subscription identification number (“MSIN”) used to identify a user account within the carrier network. In FIG. 3B, the control plane 208 of the cell site 104 establishes connectivity represented by dashed line 306 between the UE 302 and the control plane 214 of the mobile core 102 and forwards signaling traffic from the UE 302 to the control plane 214. The control plane 214 decides whether to authorize the UE 302 based on the signaling traffic. In FIG. 3C, once the authentication procedure is completed in the control plane 214, a set of dedicated transmission channels identified by dashed line 308 and 310 are established between the user plane 210 and the user plane 216. Transmission channel 308 is used to carry voice traffic between the UE 302 and the user plane 216. Transmission channel 310 is used to carry multimedia traffic between the UE 302 and the user plane 216.

Handover is the process of transferring an ongoing call or data session from a channel of a cell site connected to a mobile core to another channel of a different cell site connected to the mobile core without loss or interruption in service. Each cell site coordinates UE handovers with neighboring cell sites, using direct cell site-to-cell site links. When a call or data transmission is in a state of handover, the channel with the strongest signal can be used for the call or data transmission at a given moment or the parallel signals can be combined at the mobile core 102 to produce a clearer copy of the signal.

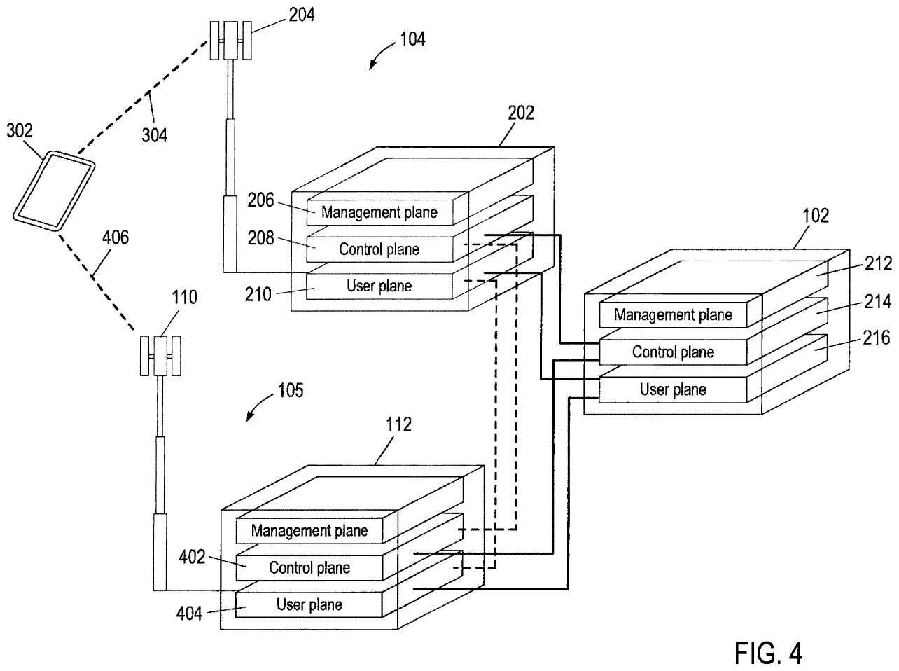

FIG. 4 shows an example of handing over the connection of the UE 302 from the cell site 104 to the neighboring cell site 105 without loss or interruption in service. In this example, the cell site 105 detects the UE 302 and receives the same signal traffic as described above with reference to FIG. 3A. The control plane 402 of the cell site 105 establishes a wireless channel via the user plane 404 with the UE 302 as represented by dashed line 406. As a result, the UE 302 has two parallel connections with the cell sites 104 and 105. The control plane 402 of the cell site 105 establishes connectivity between the UE 302 and the control plane 214 of the mobile core 102 and forwards signaling traffic from the UE 302 to the control plane 214. The control plane 214 decides whether to authorize the UE 302 based on the signaling traffic. Once the authentication procedure is complete in the control plane 214, a voice and multimedia transmission channels are established between the user plane 404 and the user plane 216. The control plane 214 may sever transmission tunnels with the cell site 104. Once the transmission channels between the user plane 210 and the user plane 216 are severed, the control plane 208 disconnects the UE 302 from the cell site 104.

TCP customizes cell site hosts to meet requirement for RAN telecommunication by orchestrating workloads from VM and container-based infrastructures for an adaptive service-delivery foundation. TCP distributes workloads from a mobile core 102 of a cellular network to cell sites located at the edge of the network and from private clouds (e.g., mobile core) to public clouds for unified coordination and management of computer systems and software at the cell sites. TCP has the advantage of automatically deploying and managing the telecommunication infrastructure. TCP is deployed in a software-defined data center (“SDDC”) at a regional data center (“RDC”).

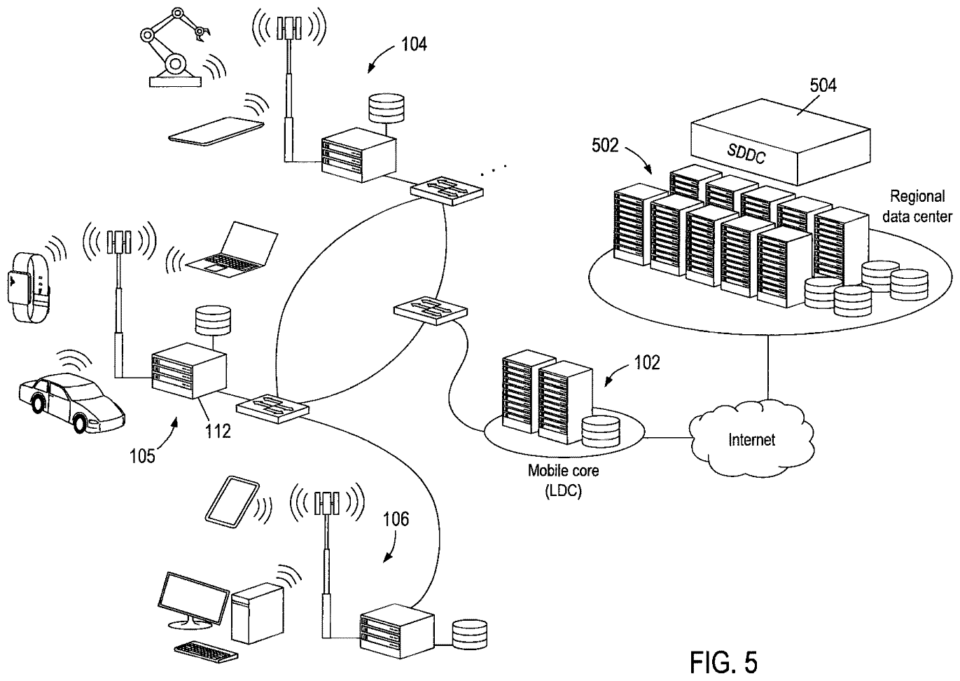

FIG. 5 shows an example of an SDDC 504 deployed at a RDC 502. The SDDC 504 runs TCP and a virtualization platform for managing the virtual environments of the cell sites, such as cell sites 104-106, and the local data center (“LDC”) used to execute the mobile core 102. The virtualization platform enables aggregated computing infrastructures that include CPU, storage, and networking resources. For example, TCP can be implemented in vSphere by VMware, Inc, which transforms a data center into an aggregated computing infrastructure. To meet the cell site 5G requirements on high network throughout, low latency, cell sites have specialized hardware, software, and customization requirements for each cell site on the RAN. For example, hosts at a 5G cell site, such as the computer systems 112 of the cell site 105, include 5G specific accelerator network cards, precision time protocol (“PTP”) devices, basic input/output system (“BIOS”) tunning, firmware updates, driver installation to support the 5G network adapters. Examples of 5G specific accelerator network cards include the Intel® vRAN dedicated accelerator ACC100. PTP devices include the Intell E810 network adapter XXV710. TCP enables aggregating these various devices across the RAN.

TCP uses a centralized management server (“VC”) to manage and customize numerous hosts of the cell sites. The VC is a centralized and extensible platform for managing a virtual infrastructure composed of VMs and virtual network. To verify the functionalities and performance with large-scale cell site hosts with limited hardware cost. TCP includes a simulation system that simulates the VC, cell site hosts, VMs, guest OSs, intelligent platform management interface (“IPMI”), and an SSH server to handle the API requests from an infrastructure automation engine and host configuration operators.

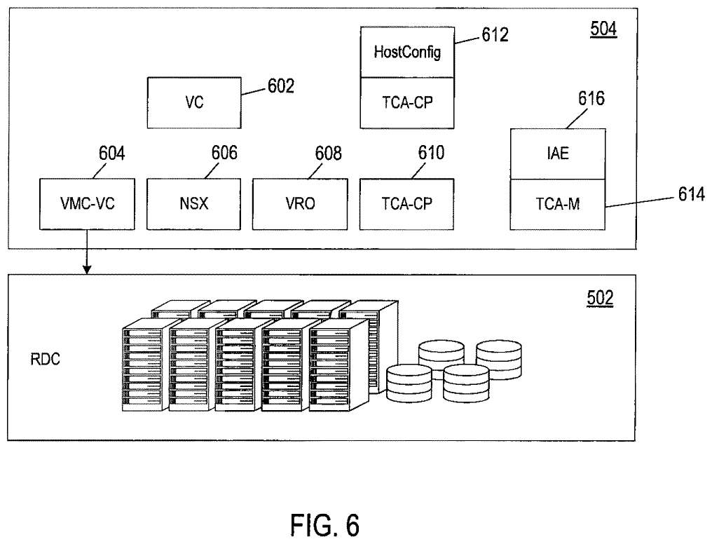

FIG. 6 shows components of the SDDC 504 that runs on the RDC 502. The SDDC 504 runs VC 602. The VC manages VMs, multiple hosts, and dependent components from a centralized location in the SDDC 504. The SDDC 504 runs a VMC-VC 604 that interfaces components of the SDDC 504 with the RDC 502. For example, the VMC-VC 604 can be VMware Cloud that runs the SDDC 504 as a service to the CSP that intends to build a 5G cellular network. The SDDC 504 runs a network virtualization platform (“NSX”) 606 that enables the implementation of virtual networks on physical networks and within a virtual infrastructure. NSX 606 uses software-defined networking to programmatically define virtual networks regardless of the infrastructure's underlying hardware. NSX 606 may be implemented using VMware NSX by VMware. Inc. The SDDC 504 runs VRO 608 which is an automated management tool that integrates workflows for VMs and containers. VRO 608 may be implemented using vRealize Orchestrator by VMware, Inc. The SDDC 504 includes a TCP control plane (“TCP-CP”) 610 that connects the virtual infrastructure of the cell sites and the mobile core 102 with the VMC-VC 604 of the RDC 502. The TCP-CP 610 supports several types of virtual infrastructure managers (“VIMs”) such as VC 602. TCP connects with TCP-CP 610 to communicate with the VIMs. The TCP-CP includes a TCP host configuration operator (“TCP-HostConfig”) 612 that configures BIOS and firmware through an intelligent platform management interface (“IPMI API”), installs drivers with hypervisor commands through an SSH connection. An SSH connection is a network communication protocol that enables cell sites and the mobile core 102 to communicate and share data. TCP-HostConfig 612 may also update firmware through a hypervisor operating system (“OS”) command. TCP includes a TCP manager (“TCP-M”) 614 that executes an infrastructure automation engine (“TCP-IAE”) 616 that automatically connects with TCP-CP 610 nodes through site pairing to communicate with the VIM. The TCP-M 614 posts workflows to the TCP-CP 610.

The SDDC 504 enables management of large-scale cell sites at a central location, such as from a console of a system administrator located at the RDC 502. Hosts of cell sites are added and managed by the VC 602 and the TCP-IAE 616 through an application programmable interface (“API”) of the virtualization platform, such as vSphere. A virtualization platform API, also called “VP API,” is a programming code that performs transmission of data between two programs. To tune and optimize large-scale cell site hosts to meet 5G RAN cell site requirements, TCP-HostConfig 612 customizes the cell sites based on 5G requirements in various aspects. For example, TCP-HostConfig 612 manages host BIOS customization, firmware upgrade. PTP device configuration, and accelerator card configuration.

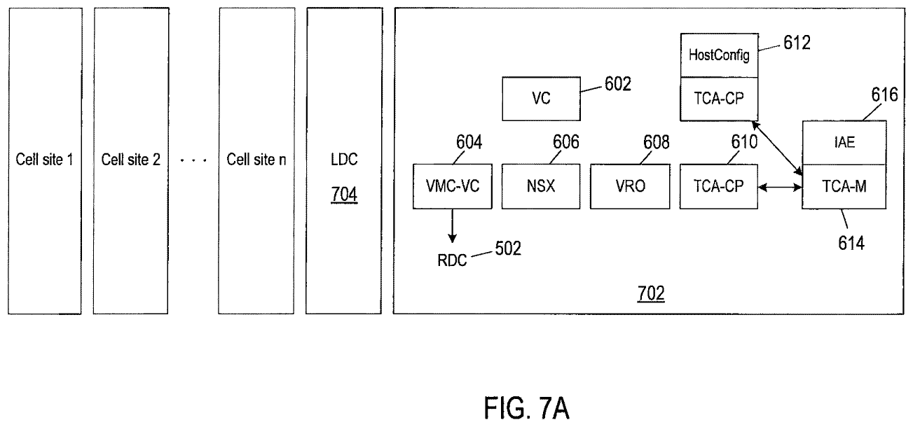

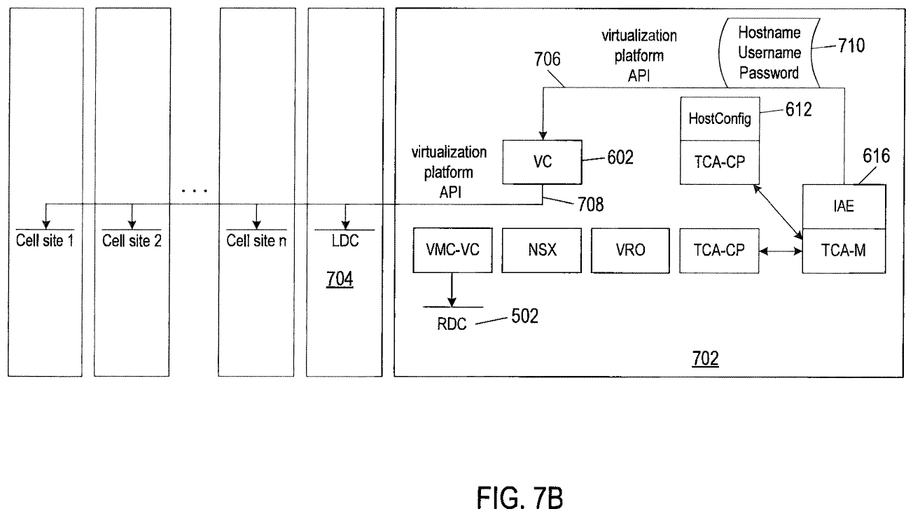

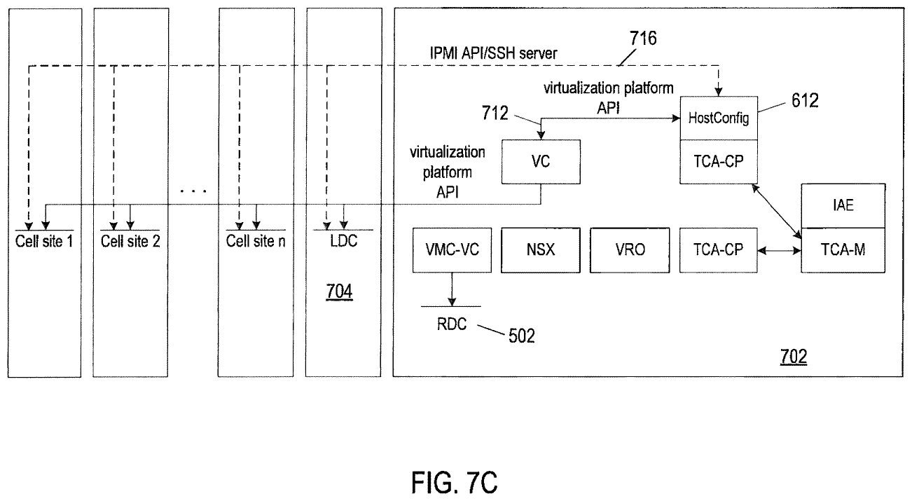

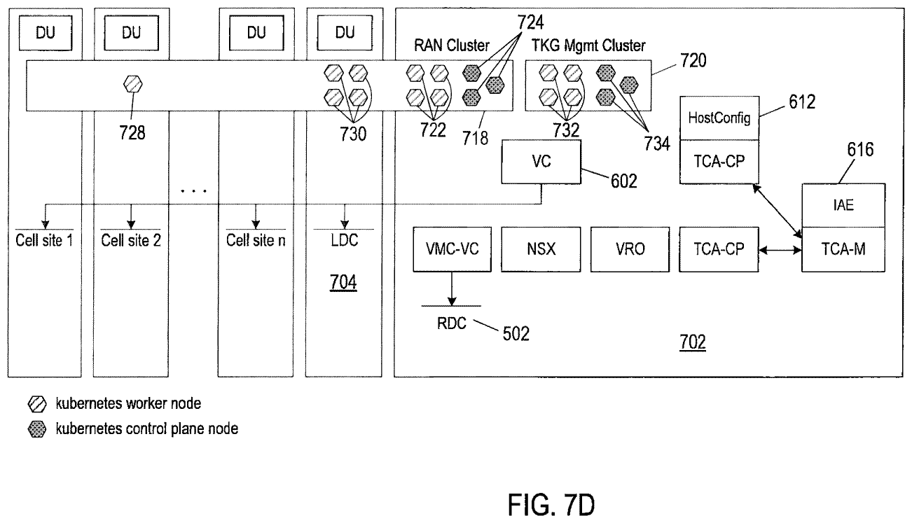

FIGS. 7A-7D show an example of configuring hosts of cell sites and LDC of a mobile core using the TCP-HostConfig 612 and the TCP-IAE 616. FIG. 7A shows an initial topology of the cellular network and the SDDC 504 running in the RDC 502. The cellular network comprises n cell sites, including cell site 1, cell site 2, and cell site n, and an LDC 704. Each host of the cell sites and the LDC runs a management plane, a control plane, and a user plane in VMs or in containers, as described above with reference to FIGS. 2A-2C. The TCP-IAE 616 adds each cell site to the VC 602 via a virtualization platform API (e.g., VC vSphere API). Network settings, such as distributed switches, port groups, and network policies, are configured for the cell site hosts by the TCP-IAE 616 using the virtualization platform API.

In FIG. 7B, directional arrows 706 and 708 represent the TCP-IAE 616 registering the hosts of the cell sites 1-n and the hosts of the LDC 704 with the VC 602 for management of the hosts by the VC 602. The TCP-IAE 612 registers each host with the VC 602 by sending login information 702 for each of the hosts of the cell sites 1-n and the hosts of the LDC 704 to the VC 602 via the virtualization platform API. The login information 710 includes “Hostname.” “Username,” and “Password” of each host of the cell sites 1-n and each of the hosts of the LDC 704. For example, the login information for hosts of the cell sites 1-n and the LDC 504 that run VMs includes “esxHostname,” “esxUsername,” and “esxPassword.”

In FIG. 7C, after each host of the cell sites 1-n and the LDC 704 have been registered with the VC 602, the TCP-HostConfig 612 customizes each of the hosts by communicating with the VC 602 via the virtualization platform API, as represented by directional arrows 712 and 714, and connecting to the hosts through an intelligent platform management interface (“IPMI”) or an (“SSH”) server, as represented by dashed directional arrow 716. A host of a cell site or the LDC 504 is customized by configuration the host to meet the 5G requirements, such as enabling a single root I/O virtualization (“SR-IOV”) for BIOS setting and enable SR-IOV for PCI express devices (e.g., PCI express card of host computer system). SR-IOV is a standard for a type of PCI device assignment that can share a single device to multiple virtual machines. SR-IOV improves device performance for VMs. The IPMI is a set of computer interface specifications for an autonomous computer subsystem that provides management and monitoring capabilities independently of the CPU, firmware (e.g., BIOS or UEFI) and operating system of the hosts of the cell sites and the hosts of the LDC 704. The IPMI defines interfaces that are used by system administrators for out-of-band management of computer systems and monitoring of the computer systems. For example, IPMI manages the computer systems of the cell sites 1-n and the computer systems of the LDC 704 that may be powered off or otherwise unresponsive by using a network connection to the hardware rather than to the operating systems or login shells of the hosts. The SSH server is a software program that uses a secure shell protocol to form connections to the remote computer systems of the cell sites 1-n and the computer systems of the LDC 704. The secure shell protocol securely exchanges data between two computers over an untrusted network. The SSH server protects the privacy and integrity of the transferred identities, data, and files.

After configuring the hosts of the cell sites 1-n and the hosts of the LDC 704 as described above with reference to FIG. 7C, a RAN cluster represented by bar 718 is deployed and a Tanzu Kubernetes Grid (“TKG”) management cluster 720 is deployed as shown in FIG. 7D. The RAN cluster 718 includes container orchestration platform worker nodes (e.g., Kubernetes worker nodes) denoted by hash-marked hexagons, such as hash-marked hexagons 722. The RAN cluster 718 includes container orchestration platform control plane nodes (e.g., Kubernetes control plane nodes) denoted by shaded hexagons, such as shaded hexagons 724. In this example, the RAN cluster 718 includes a worker node 728 deployed on a host at the cell site 2 and includes four worker nodes 730 deployed on hosts at the LDC 704. The worker node 728 at the cell site 2, the four worker nodes 730 at the LDC 704, and the worker nodes 722 of the RDC 702 are managed by the control plane nodes 724 from a centralized console located in RDC 502. The control plane nodes 724 include an API server, a scheduler that monitors the pods and assigns the pods to run on specific hosts, and a controller manager that runs the controllers in the background, such as a workload controller. The workload controller is responsible for monitoring and responding when a worker node fails. The control plane nodes 724 may also include a replication controller that maintains the number of pods running in the worker nodes and controls the number of identical copies of pods that may be running elsewhere in the RAN cluster. The control plane nodes 724 provide central management of the worker nodes in the cell sites and the LDC 704. The VC 602 provides a central manager of the virtual environments created by the VMs running in the cell sites 1-n and the LDC 704 from the centralized console located in RDC 502. The TKG management cluster 720 includes worker nodes 732 and control plane nodes 734. The TKG management cluster 720 is a Kubernetes cluster that runs cluster API operations on a specific cloud provider to create and manage workload clusters on that provider.

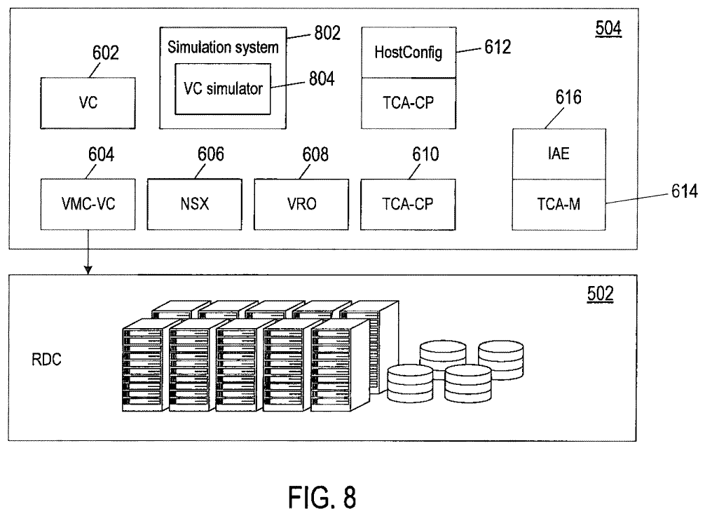

FIG. 8 shows components of the SDDC 504 that runs on the RDC 502 and includes a simulation system 802. CSPs require a high density of cell sites over a given area to meet scale requirements for a 5G cellular network. The simulation system 802 provides a test infrastructure for end-to-end scale verification for TCP-IAE 616 and TCP-HostConfig 612 of multiple mock hosts and a mock VC of a 5G cellular network. The simulation system 802 provides end-to-end scale tests without any changes to the TCP-IAE 616 and TCP-HostConfig 612 of the TCP. The simulation system 802 simulates the communication illustrated in FIGS. 7B and 7C but with a mock VC and mock hosts of the cell sites and LDC. A VM based hypervisor (“ESX”), such as ESXi by VMware Inc., is widely used in scale tests. However, current VM hypervisors do not satisfy 5G device requirements. The simulation system 802 includes a VC simulator 804 that simulates a VC managing multiple hosts and VMs. VC simulator 804 is a tool that simulates multiple VMs. VC simulator 804 creates a model with a datacenter, hosts, cluster, resource pools, networks, and a datastore. Resources can also be created and removed from the simulation using the virtualization platform API. VC simulator 804 uses the virtualization platform API to generate an inventory, which includes a collection of virtual and physical objects, such as a datastore, network, folder, resource pool. When adding a new host to the VC simulator 804, the new host is generated based on a pre-compiled ESX model. A compiled model is a pre-defined ESX model with hardcoded metadata, including, for example, CPU, memory, vendor, network, and device configurations. New mock hosts are added based on the ESX model. In other words, all the hosts have the same default configuration of the ESX model. The new host of the VC simulator 804 has a default inventory of objects, such as a datastore, and 5G associated peripheral component interconnect (“PCI”) devices. This does not match the simulation requirement for RAN cell sites because multiple TCP functionalities depend on information about PCI devices of the cell site hosts, which is retrieved through the virtualization platform API. During scale tests performed on the mock hosts by the simulation system 802, changes to TCP are not permitted. However, the VC simulator 804 may be customized by adding features to generate mock hosts with required devices and configurations. As described above with reference to FIG. 7B, to register a cell site host with the VC 602, TCP-IAE 616 calls the virtualization platform API ‘addStandaloneHost’ with hostname, username, and password parameters of the host. However, VC simulator 804 does not know the PCI devices or configuration requirements for the mock hosts of the cell sites.

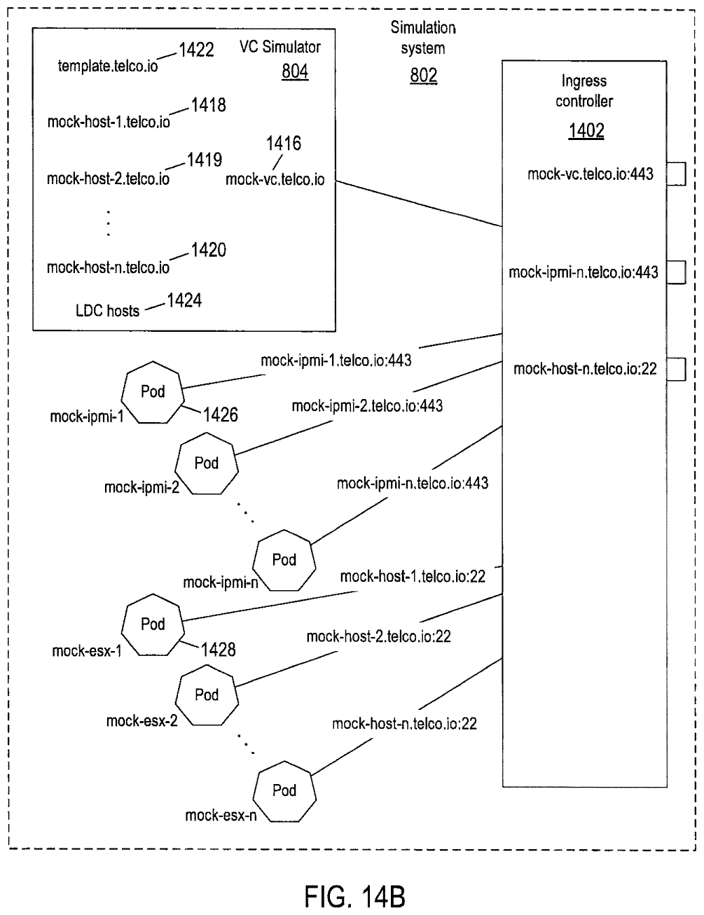

The simulation system 802 described below is a cloud native simulation system that comprehensively simulates RAN cell site hosts as mock hosts using the VC simulator 804. IPMI simulator. ESXCLI and ESX OS command simulator, and an ingress load balance system. The simulation system 802 generates one or more mock hosts with a specific inventory of objects, such as network, datastore, and 5G devices (e.g., PCI devices). The simulation system 802 receives as input (1) an ‘addStandaloneHost’ API that passes the virtualization platform inventory of objects to the VC simulator 804, and (2) a host template that provides the inventory of object details, as described below with reference to FIGS. 14A-14B. The VC simulator 804 generates the mock hosts with objects that match the object requirements of the host template. The parameter elements of the ‘addStandaloneHost’ API are given in the following table:

### Table 1 of Parameter Elements of “addStandaloneHost” API

| Parameter | | | |
|---|---|---|---|
| element | Purpose | Example | Description |
| Hostname | Mock host | mock-host-1.telco.io | Add mock-host- |
| | name | | 1.telco.io to VC |
| | | | simulator |
| Password | Objects | Hostsystem- | Objects requirements |
| | requirement | HardwareDevice- | to set HostSystem, |
| | for new host | LocalDataStore-DVS | HardwareDevice, |
| | | | localDatastore, DVS |
| | | | for newly added host |
| Username | Template | template.telco.io | The object data |
| | host | | should be the same as |
| | | | the template host |

The simulation system 802 is deployed in a kubernetes cluster the RDC 502 with a helm chart. The image includes prepared VC inventories of objects, such as data center, datastore, network, host system, resource pool as xml files. The “Hostname” parameter element in Table 1 is the fully qualified domain name (“FQDN”) of the host at the cell site or the LDC. In the following discussion, the example domain name of the mock hosts of the cell sites and the LDC is “telco.io”. A FQDN is the complete domain name for a specific mock host of a cell site or the LDC that can be found on the cellular network.

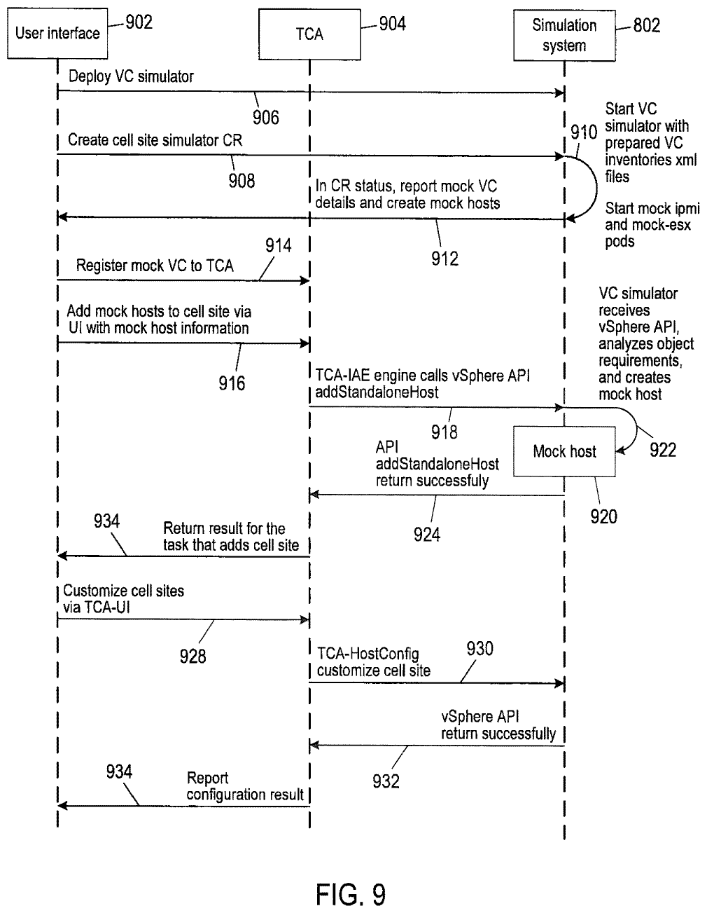

FIG. 9 shows an example workflow for configuring mock hosts of cell sites and an LDC of a cellular network. The workflow includes operations that are performed in response to instructions received by a user via a user interface (“UP”) represented by block 902, operations performed by components of a TCP are represented by block 904, and a block represents the operations performed by the simulation system 802. Directional arrow 906 represents instructions sent to the simulation system 802 via the UI 902 to deploy the VC simulator 804 that simulates the functionality of the VC 602 for mock hosts. The VC simulator 804 is deployed in a pod of the simulator system 802. Directional arrow 908 represents instructions sent to the simulation system 802 via the UI 902 to create a cell site simulator custom resource (“CR”) for declaring desired states of the mock VC and the mock hosts. The sell site simulator CR is the input that describes the requirements for the mock VC and the mock hosts.

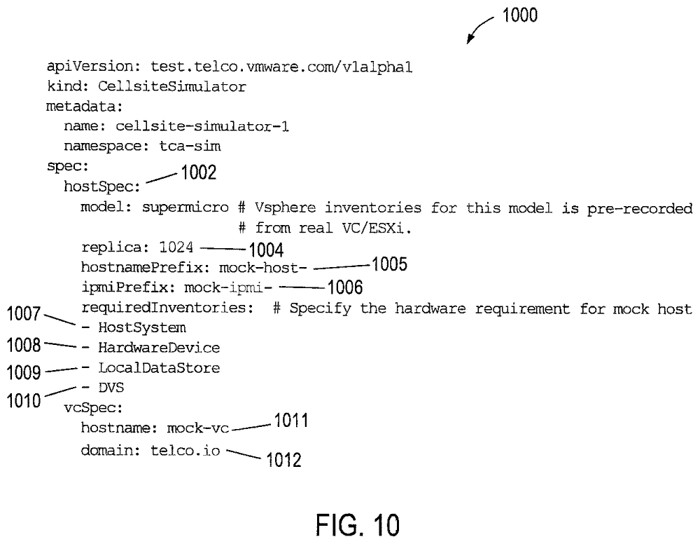

FIG. 10 shows an example cell site simulator CR input 1000 to start the simulation system 802 as represented by directional arrow 908. In other words, directional arrow 908 represents instructions sent to the simulation system 802 via the UI 902 to create a cell site simulator CR and declare a desired state of a mock VC and desired states for mock hosts. The input contains information that is used by the simulation system 802 to create the mock VC and, in this example, generate information for 1024 mock hosts. The input 1000 includes specifications 1002 for each of 1024 hosts in line 1004. Each mock host has a host name prefix, “mock-host-”, in line 1005 and an IPMI prefix, “mock-ipmi-”, in line 1006. The input includes the inventory of objects the mock hosts are configured with in lines 1007-1010. The input includes the hostname, “mock-vc”, for the mock VC in line 1011. The input includes the domain name, “telco.io”, used by the mock VC and mocks hosts in line 1012. The combination of “mock-vc” and “telco.io” gives a FQDN for the mock VC as “mock-vc.telco.io”, which is used as the “vcHostname”.

Returning to FIG. 9, directional arrow 910 represents the simulation system 802 starts running the VC simulator 804 with prepared VC object inventories based on xml files. The simulator system 802 creates the mock VC and starts running mock IPMI and mock ESX pods in the simulation system 802 described below reference to FIGS. 14A-14B. In other words, the simulation system 802 provisions mock VC pods for the mock VC and provisions mock IPMI pods and mock ESX pods for the mock hosts. The simulation system 802 returns a report of the mock VC and creates login information for each of the mock hosts to the UI 902 as represented by directional arrow 912. When the CR status stage turns to provisioned. VC simulator 804 is running, mock pods for IPMI server and SSH server are running, hostname, username, and password are generated for each of the mock hosts of the cellular network, but the mock hosts of the cell sites and the LDC are not, at this point, registered with the mock VC,

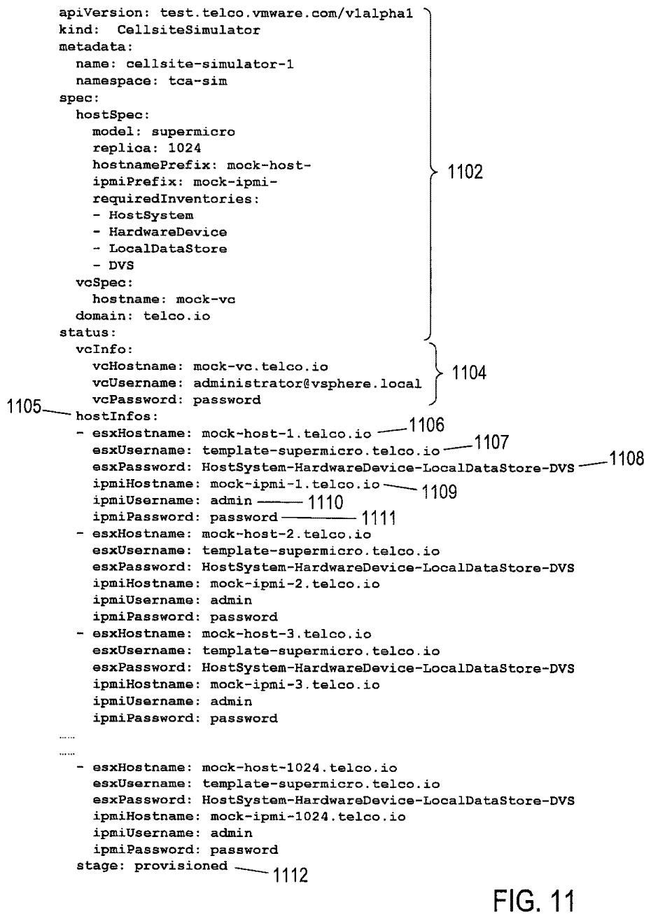

FIG. 11 shows example details of mock hosts that are generated in CR status field for future deployment in cell sites and an LDC. Lines 1102 repeat the input shown in FIG. 10. Lines 1104 contains the vcHostname (i.e., FQDN of the mock VC), vcUsername, and vcPassword of the mock VC. Line 1105 marks the beginning of the output from the simulation system 802 for each of 1024 mock hosts. The simulation system 802 outputs an ESX hostname, ESX username, and an ESX password for each mock host. The simulation system 802 outputs an IPMI hostname, IPMI username, and an IPMI password for each mock host. For example, mock host 1 has esxHostname (i.e., FQDN of the mock host), esxUsername, and esxPassword in lines 1106-1108. The ipmiHostname (i.e., FQDN of the mock ipmi), ipmiUsername, and ipmiPassword for the IPMI are given in lines 1109-1111. The final line 1112 indicates that the VC simulator 804 is running, the mock VC has been provisioned for the mock VC, and the mock ESX pods and the IPMI pods have been provisioned for each of the mock hosts.

Returning to FIG. 9, the UI 902 displays a TCP UI of the UI 902 that enables the user to register the mock VC with the TCP-CP of the TCP 904 as represented by directional arrow 914. The vcHostname (i.e., FQDN of the mock VC), vcUsername. and vcPassword of the mock VC that are output in FIG. 11 are input to the TCP-CP. The TCP UI 902 also displays an interface that enables the user to register mock hosts with the mock VC using host information as represented by directional arrow 916. The host information includes ESX and IPMI hostnames, usernames, and passwords of the 1024 hosts in FIG. 11, which are input to the TCP-CP.

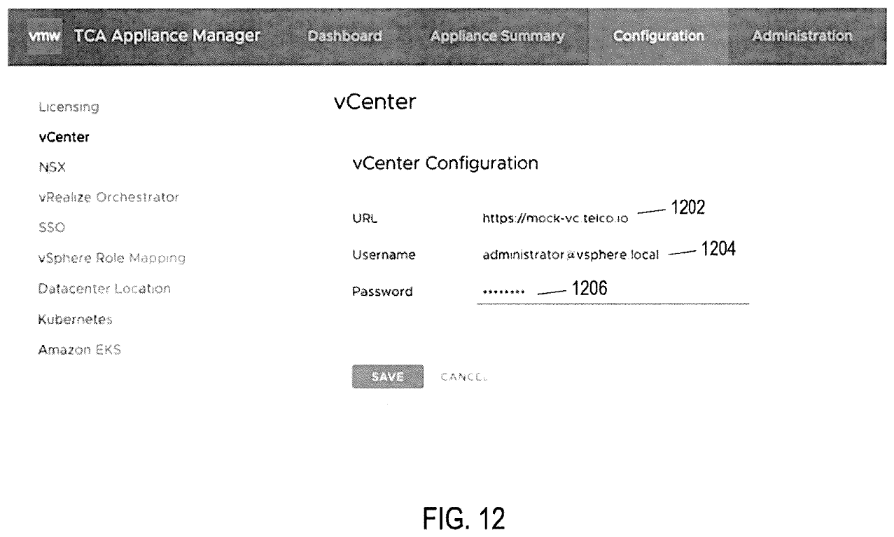

FIG. 12 shows an example TCP UI of the UI 902 for registering the mock VC with the TCP-CP of the TCP 904. In FIG. 12, vcHostname (i.e., FQDN of the mock VC), vcUsername, and vcPassword of the mock VC are input to the TCP-CP. A user inputs a URL that specifies the network location of a mock VC with the FQDN “mock-vc.telco.io” in text field 1202. The user also inputs the vcUsername of a system administrator with access to the simulation system in text field 1204 and inputs the vcPassword that permits access to the simulation system in text field 1206.

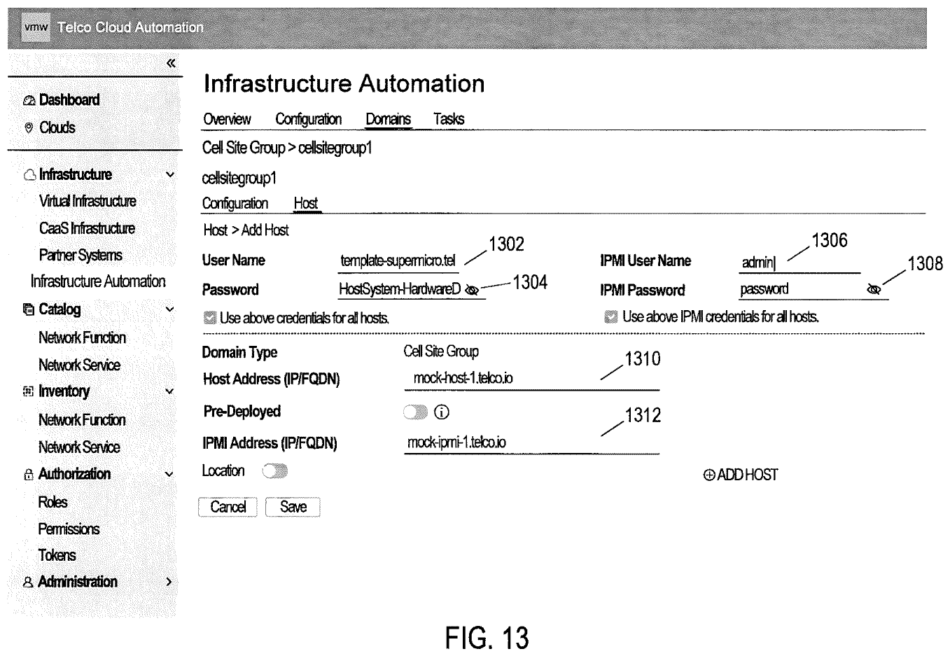

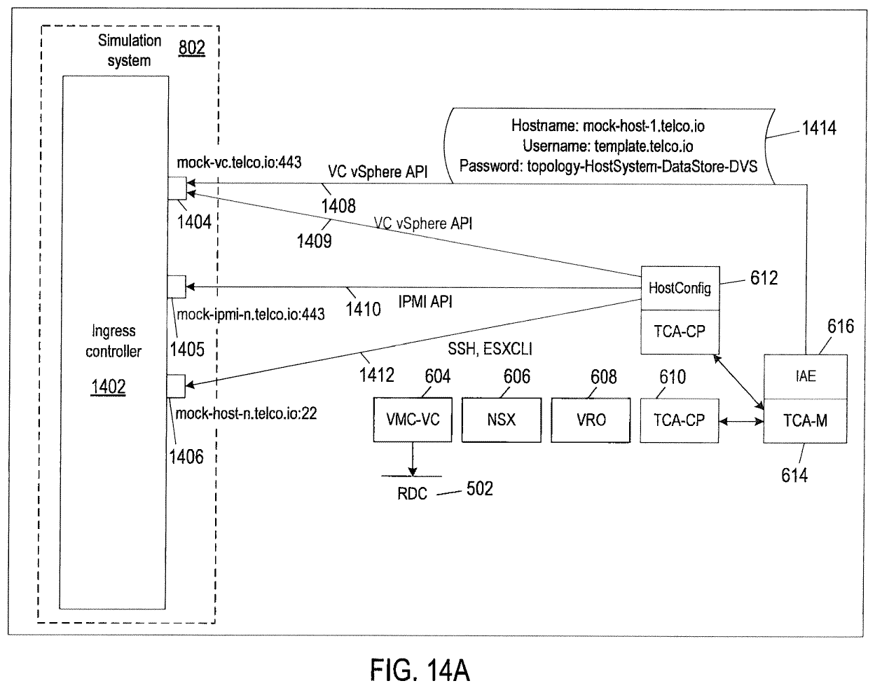

FIG. 13 shows an example TCP UI of the UI 902 for adding a mock host of a cell site 1 with mock host information. The mock host information is the ESX and IPMI hostnames, usernames, and passwords for the cell site 1 given in the output shown in FIG. 11. In this example, a user inputs the esxUsername 1107 in text field 1302, inputs the esxPassword 1108 in text field 1304, inputs ipmiUsername 1110 in text field 1306, and inputs ipmiPassword 1111 in text field 1308. The user inputs esxHostname “mock-host-1.telco.io” (i.e., FQDN of the mock host of cell site 1) in text field 1310 and the ipmiHostname “mock-ipmi-1.telco.io” is text field 1312. The ESX and IPMI hostnames, usernames, and passwords are used by the TCP-IAE to register the mock hosts with the mock VC.

Returning to FIG. 9. TCP-CP of the TCP 904 receives the registration of the mock VC and mock host information as described above with reference to FIGS. 12 and 13, respectively. The TCP-IAE of the TCP calls the virtualization platform API “addStandaloneHost” to send mock host object requirements to the VC simulator 804 of the simulation system 802 as represented by directional arrow 918. The “addStandaloneHost” API creates a mock host 920 using the VC simulator 804 as represented by directional arrow 922. The VC simulator 804 receives object requirements from the addStandaloneHost API and creates the mock host with the required objects based on the host template.

FIGS. 14A-14B shows an exploded view of the simulation system 802 for creating mock hosts of RAN cell sites and a mobile core of an LDC. In FIGS. 14A-14B, the simulation system 802 includes the VC simulator 804, mock IPMI pods, mock ESX pods, and an ingress controller 1402. In FIG. 14A, the ingress controller 1402 has three input ports 1404-1406 for receiving information. Port 1404 receives information from the virtualization platform API as indicated by directional arrows 1408 and 1409. Port 1405 receives information from the IPMI API as indicated by directional arrow 1410. Port 1406 receives information from the SSH server. The TCP-IAE 616 uses the virtualization platform API to send hostname, username, and password information 1414 of the mock hosts to the ingress controller 1402 of the simulation system 802. TCP-HostConfig 612 uses the virtualization platform API, the IPMI API and the SSH server or ESX command over SSH to send mock host configuration information to the ingress controller 1402 of the simulation system 802. TCP-IAE 616 and TCP-HostConfig 612 communicate with the mock VC on port 1404 using FQDN mock-vc.telco.io.443. TCP-HostConfig 612 connects to ESX OS with SSH service on port 1406 using FQDN mock-esx-n.telco.io:22, where n identifies the host. For example, n=1, . . . , 1024 for the 1024 hosts in FIG. 11. TCP-HostConfig 612 connects with each of the IPMI pods shown in FIG. 14B on port 1405 using FQDN mock-ipmi-n.telco.io:443 1610. The ingress controller 1402 manages and directs the flow of the information received from the virtualization platform APIs, IPMI API, and SSH server within the simulation system 802.

In FIG. 14B, the VC simulator 804 is implemented in a pod of the RDC 502. The simulation system 802 generates a new mock host with 5G associated devices and registers the mock host with the mock VC without any changes to TCP-IAE 616 or the TCP-HostConfig 612. The required virtualization platform inventory objects are attached to the mock host. Unlike adding actual hosts to the actual VC described above with reference to FIGS. 2 and 3, which requires username and password to communicate with the host, username and password are not needed when cloning a mock host within the VC simulator 804. The approach uses the parameter elements in the table above to pass the requirements to customized VC simulator 804. The mock hosts created by the VC simulator 804 are a group inventory of object data that is stored in memory. The VC simulator 804 copies the required inventory of objects from the host template. The mock hosts are created from the host template. The objects details are obtained from the host template which is loaded into the VC simulator 804. The VC simulator creates a mock VC with FQDN mock.vc.telco.io 1416 and creates n mock hosts with FQDNs 1418-1420 of the n cell sites based on the host template with FQDN template.telco.io 1418. The VC simulator 804 also creates mock hosts for the LDC 1424. For each mock host created by the VC simulator 804, the VC simulator 804 also creates a corresponding mock IPMI pod and a mock ESX pod for each mock host. For example, the VC simulator 804 creates an IPMI pod 1426 with hostname mock-ipmi-1 and ESX pod 1428 with hostname mock-esx-1 for the mock host 1. A mock IPMI pod is an IPMI interface simulator that responds to IPMI requests from the TCP-HostConfig 612. A mock ESX pod is an interface simulator that mocks SSH server and ESX OS commands received from TCP-HostConfig 612. In this example, the IMPI API used by the TCP-HostConfig 612 to communicate with the IPMI pod 1426 is FQDN mock-ipmi-1.telco.io:443. The SSH server used by the TCP-HostConfig 612 to communicate with the ESX pod 1428 is FQDN mock-host-1.telco.io:22.

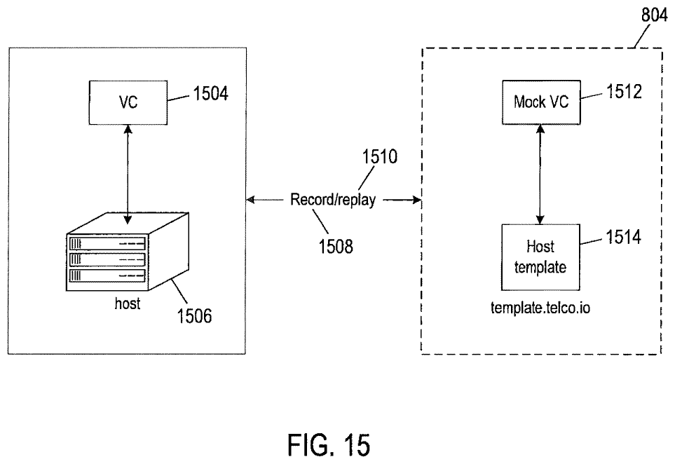

FIG. 15 shows an example of a VC simulator 804. The object inventory for a real VC 1504 and a host 1506 are recorded (i.e., saved) 1508 as xml files. Host 1506 is a real host with 5G devices. The VC simulator 804 replays (i.e., clones) 1510 the object inventory of the VC 1504 and the host 1506 to run as a mock VC 1512 with a host template 1514 managed by mock VC 1512. The FQDN of the host template is template.telco.io.

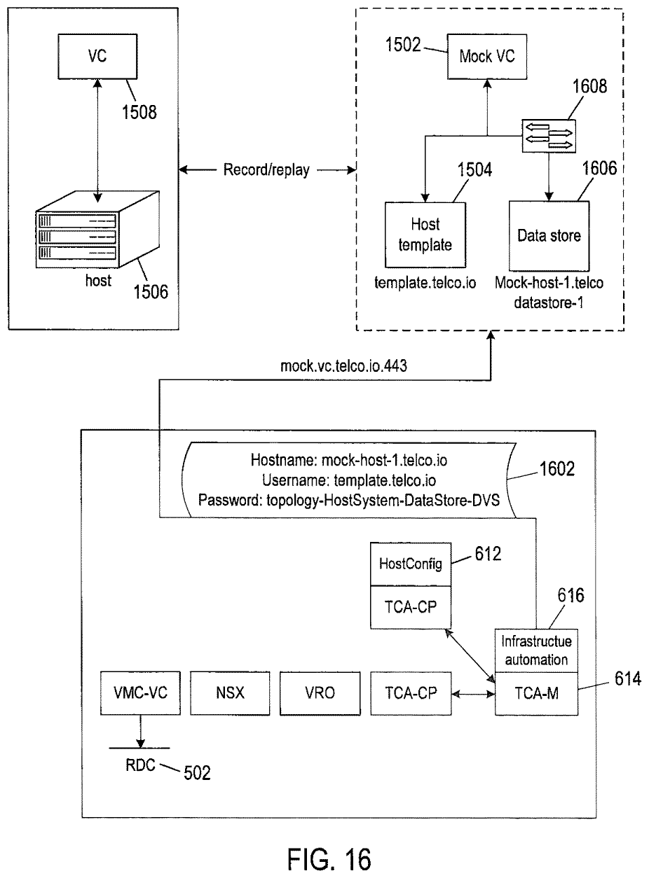

FIG. 16 shows an example of a mock host of a cell site that is created and registered with the mock VC in FIG. 15. The TCP-IAE 616 registers the mock host 1504 with the mock VC by sending input information to the mock VC 1502. The input information 1602 contains the hostname, username, and password of a desired new mock mock-host-1.telco.io. In this example, mock host, mock-host-1.telco.io, is created and a datastore and switch are created for the mock host.

Returning to FIG. 9, after the mock host 920 has been created, the VC simulator 804 notifies the TCP 904 that the mock host 920 has been successfully created and added to the VC for management as represented by directional arrow 924. Note that from UI 902, the user intends to add a cell site. From backend, the VC simulator 802 creates the mock host 920 and adds the mock host 920 to the VC for management. The TCP 904 displays in the UI 902 that the cell site of mock host 920 has been successfully added to the cell site. The user customizes (i.e., configures) the mock host of the cell site that will be used to configure a real host using the TCP UI as represented by directional arrow 928. For example, the mock host is customized to enable an SR-IOV for a BIOS, firmware, and PCI devices. The TCP-HostConfig sends the user instructions to the simulation system 802 to customize (i.e., configure) the cell site that contains the mock host in accordance with the user instructions as represented by directional arrow 930.

Returning to FIG. 9, the simulation system 802 uses the virtualization platform API to report to the TCP 904 that the cell site has been successfully configured in accordance with the user requested customization as represented by directional arrow 932. The TCP 904 displays in the TCP UI that the cell site has been successfully configured.

The simulator system 802 tests whether the TCP is able to support the large number of hosts of 5G configured cell sites and LDC as described above with reference to FIGS. 7A-7D. For example, the number of cells sites n can be as many as 2000. The VC simulator 804 of the simulator system 802 serves as a VC for testing the TCP operations of establishing the 2000 mock hosts of the cell sites and the LDC in the same manner as described above with reference to FIGS. 7A-7D. The mock VC and mock hosts are used to respond to any communications from the TCP to test the functionality and performance of TCP with large numbers of hosts configured to implement a 5G cellular network. When the simulation proves the functionality and performance of the TCP is successful, actual hosts for cell sites of an actual 5G cellular network are constructed with configurations that match the configurations of the mock hosts.

It is appreciated that the previous description of the disclosed embodiments is provided to enable any person skilled in the art to make or use the present disclosure. Various modifications to these embodiments will be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A method, stored in one or more data-storage devices and executed using one or more processors of a computer system, for verifying functionality and performance of an automated telecommunication cloud platform (“TCP”), the method comprising:
creating a mock centralized management server (“VC”) of a VC simulator based on a template;
creating one or more mock hosts that run in the VC simulator based on a host template with 5G associated devices;
registering the mock VC with the TCP;
registering the one or more mock hosts with the mock VC using hostname, username, and password associated with each of the one or more mock hosts;
configuring objects of the mock hosts using the TCP according to user input received via a TCP user interface; and
testing response of the mock VC and the one or more mock hosts to communications from the TCP.

2. The method of claim 1 wherein creating the mock VC includes starting mock intelligent platform management interface (“IMPI”) pods and mock hypervisor pods for the mock VC.

3. The method of claim 1 wherein creating the one or more mock hosts comprises the VC simulator:
receiving hostnames, usernames, and passwords of the one or more mock hosts via virtualization platform application programmable interface (“API”); and
creating the one or more mock with objects based on a host template.

4. The method of claim 3 wherein registering the mock VC with the TCP comprises registering the mock VC with a control plane of the TCP using hostname, username, password of the mock VC.

5. The method of claim 1 wherein registering the one or more mock hosts with the mock VC using hostname, username, and password associated with each of the one or more mock hosts comprises sending the hostnames, usernames, and passwords of the mock hosts to an infrastructure automation engine (“IAE”) of the TCP; and the TCP-IAE using the hostnames, usernames, and passwords of the mock hosts to register the one or more hosts with the mock VC.

6. The method of claim 1 wherein creating the one or more mock hosts that run in the VC simulator includes the VC simulator:
creating the one or more mock hosts; and
creating a mock intelligent platform management interface (“IPMI”) pod and a hypervisor pod for each of the one or more mock hosts.

7. A computer system that verifies functionality and performance of an automated telecommunication cloud platform (“TCP”), the system comprising:
one or more processors;
one or more data-storage devices; and
machine-readable instructions stored in the one or more data-storage devices that when executed using the one or more processors controls the system to execute operations comprising:
creating a mock centralized management server (“VC”) of a VC simulator based on a template;
creating one or more mock hosts that run in the VC simulator based on a host template with 5G associated devices;
registering the mock VC with the TCP;
registering the one or more mock hosts with the mock VC using hostname, username, and password associated with each of the one or more mock hosts;
configuring objects of the mock hosts using the TCP according to user input received via a TCP user interface; and
testing response of the mock VC and the one or more mock hosts to communications from the TCP.

8. The computer system of claim 7 wherein creating the mock VC includes starting mock intelligent platform management interface (“IMPI”) pods and mock hypervisor pods for the mock VC.

9. The computer system of claim 7 wherein creating the one or more mock hosts comprises the VC simulator:
receiving hostnames, usernames, and passwords of the one or more mock hosts via virtualization platform application programmable interface (“API”); and
creating the one or more mock with objects based on a host template.

10. The computer system of claim 7 wherein registering the mock VC with the TCP comprises registering the mock VC with a control plane of the TCP using hostname, username, password of the mock VC.

11. The computer system of claim 7 wherein registering the one or more mock hosts with the mock VC using hostname, username, and password associated with each of the one or more mock hosts comprises sending the hostnames, usernames, and passwords of the mock hosts to an infrastructure automation engine (“IAE”) of the TCP; and the TCP-IAE using the hostnames, usernames, and passwords of the mock hosts to register the one or more hosts with the mock VC.

12. The computer system of claim 7 wherein creating the one or more mock hosts that run in the VC simulator includes the VC simulator:
creating the one or more mock hosts; and
creating a mock intelligent platform management interface (“IPMI”) pod and a hypervisor pod for each of the one or more mock hosts.

13. A non-transitory computer-readable medium encoded with machine-readable instructions that causes one or more processors of a computer system to perform operations comprising:
creating a mock centralized management server (“VC”) of a VC simulator based on a template;
creating one or more mock hosts that run in the VC simulator based on a host template with 5G associated devices;
registering the mock VC with the TCP;
registering the one or more mock hosts with the mock VC using hostname, username, and password associated with each of the one or more mock hosts;
configuring objects of the mock hosts using the TCP according to user input received via a TCP user interface; and
testing response of the mock VC and the one or more mock hosts to communications from the TCP.

14. The medium of claim 13 wherein creating the mock VC includes starting mock intelligent platform management interface (“IMPI”) pods and mock hypervisor pods for the mock VC.

15. The medium of claim 13 wherein creating the one or more mock hosts comprises the VC simulator:
receiving hostnames, usernames, and passwords of the one or more mock hosts via virtualization platform application programmable interface (“API”); and
creating the one or more mock with objects based on a host template.

16. The medium of claim 6 wherein registering the mock VC with the TCP comprises registering the mock VC with a control plane of the TCP using hostname, username, password of the mock VC.

17. The medium of claim 13 wherein registering the one or more mock hosts with the mock VC using hostname, username, and password associated with each of the one or more mock hosts comprises sending the hostnames, usernames, and passwords of the mock hosts to an infrastructure automation engine (“IAE”) of the TCP; and the TCP-IAE using the hostnames, usernames, and passwords of the mock hosts to register the one or more hosts with the mock VC.

18. The medium of claim 13 wherein creating the one or more mock hosts that run in the VC simulator includes the VC simulator:
creating the one or more mock hosts; and
creating a mock intelligent platform management interface (“IPMI”) pod and a hypervisor pod for each of the one or more mock hosts.
